(19) United States
(12) Patent Application Publication
(10) Pub. No.: US 2021/0347102 A1
(43) Pub. Date: Nov. 11, 2021

(54) BOTTLE, AND AN INSERT AND A MOULD FOR MAKING THE BOTTLE

(71) Applicant: Orora Packaging Australia Pty Ltd, Hawthorn (AU)

(72) Inventor: Craig BIRBECK, Kingsford (AU)

(21) Appl. No.: 17/314,326

(22) Filed: May 7, 2021

(30) Foreign Application Priority Data
May 8, 2020 (AU) 2020901485

(51) Int. Cl. B29C 49/52; B65D 1/02; B65D 1/40

(52) U.S. Cl. CPC B29C 49/52; B65D 1/0276; B29C 2049/4858; B65D 1/40; B65D 1/0207

(57) ABSTRACT

A mould for forming a bottle comprising a base at one end, a neck with an opening at an opposing end, a side wall extending from the base, and a transition between the side wall and the neck, with a lower section including a debossed section that defines a bottle identification indicium, the mould comprising a mould cavity that defines the shape of the bottle, with the mould being formed to receive a replaceable mould insert that includes an embossed section for forming the debossed section in the lower section of the bottle produced in the mould.

### FIELD OF INVENTION

The present invention relates to a bottle that has a debossed section in a lower section of the bottle that define bottle identification indicium.

The invention also relates to a mould for blow moulding the bottle described above.

The invention also relates to a mould insert that has an embossed section that in use forms part of a blow-moulding mould and forms the debossed section of the above bottle blow-moulded in the mould.

The invention also relates to a mould assembly that comprises a mould and a mould insert retained in the mould.

### BACKGROUND

Liquor and wine are typically marked with identification indicia to provide information about the bottle. For example, wine bottles are usually marked with a series of dots and alphanumeric characters which identify the company producing the bottle and the section of a multi-section forming machine in which the bottle was made.

These indicia allow an operator to quickly identify the source and the section in which a damaged bottle were made so that the necessary action, such as stopping production or repairing the bottle forming machine, can be taken to avoid further damaged bottles from being produced.

Preserving the bottle indicia is important because any damage to the indicia can render them unreadable or may result in the damaged indicia forming fracture points which may lead to catastrophic failure of the bottle. This is a problem for bottles made from fragile or brittle material such as glass.

Typically, the bottle identification indicia are embossed onto the heel of a bottle to minimize its impact on the overall aesthetic of the bottle. However, one disadvantage of positioning the embossed identification indicia at this location is that the indicia are in constant contact with similar indicia of an adjacent bottle when the bottles are transported on filling and packaging lines. This is particularly an issue on modern fast-moving bottle filling lines.

To minimize the risk of this occurring, some wine bottles to have an in-sweep in the heel area to reduce the likelihood of the embossed identification indicia of one bottle from contacting another.

Bottle design is continuously evolving with customers currently favouring bottles with a squared heel. Such designs can be seen in a range of premium wine and whisky bottles. This poses a challenge for bottle designers because of the increased risk of damage to the identification indicia rendering them unreadable. Damaged indicia may also adversely affect the stability of the bottles.

It is desirable to provide a bottle possessing bottle identification indicia that minimizes damage to the bottle identification indicia by contact with another bottle when travelling on a filling or packaging line.

### SUMMARY OF THE INVENTION

The present invention provides a bottle comprising a base at one end, a neck with an opening at an opposing end, a side wall extending from the base, and a transition between the side wall and the neck, with a lower section including a debossed section that defines a bottle identification indicium.

The bottle may be made from a range of materials. Suitably, the bottle is made from a brittle material such as glass.

In this specification, the term “debossed” refers to an indented section of the bottle. This is in contrast with the term “embossed” which refers to a section of the bottle which stands out in relief.

In this specification, the term “in-swept heel” refers to the shape of a bottom region of the bottle in which the angle between a side wall and a base of the bottle is greater than 90°.

In this specification, the term “squared heel” refer to the shape of a bottom region of the bottle in which the angle between a side wall and a base of the bottle is 90°.

The invention is particularly adapted for bottles having a squared heel. However, a skilled person would appreciate that the invention is also adapted for bottles having an out-swept heel in which the angle between a side wall and a base of the bottle is less than 90°.

The present invention seeks to minimise the number of contact points of a bottle with an adjacent bottle when the bottles are travelling on a filling or packaging line. The present invention seeks to achieve this by reducing the number of protrusions on the bottle.

Debossing a bottle identification indicium removes the bottle identification indicium as an impact point between adjacent bottles or a bottle and mechanical equipment when the bottle is on a packaging or filling line. This minimises the risk of the bottle identification indicium from being damaged and rendered unreadable. Debossing an area of the bottle in which the bottle identification indicium is located may also provide the same effect. This is particularly important for bottles made from a brittle material which has a higher tendency to fracture when impacted, for example while on a packaging or filling line. For these bottles, the embossed bottle identification indicium typically forms protrusions which can be easily sheared off or crushed when impacted. In contrast, bottles made from flexible material such as plastic are more resistant to the identification indicium being damaged.

The bottle identification indicium may be one of more of CID (cavity identification) dots, cavity numbers and bottle identification text. CID and cavity numbers are specifically used for glass bottles, suitably, glass wine bottles.

The present invention also provides a mould for forming the above bottle, the mould comprising a mould cavity that defines the shape of the bottle, with the mould being formed to receive a replaceable mould insert that includes an embossed section for forming the debossed section in the lower section of the bottle produced in the mould. The mould may be a split mould.

Suitably, the mould may be a two-part split mould.

The mould may include a mould insert that forms the debossed section in the lower section of the bottle produced in the mould.

The mould may be configured to receive any number of mould inserts and may include a corresponding number of mould insert cavities to receive the mould inserts.

The mould insert cavity may be any suitably shaped cavity or formation of the mould that can receive the mould insert.

The mould insert cavity may be shaped such that sections or regions of the replaceable mould insert adjacent to the embossed section forms a continuous surface with sections or regions of the mould adjacent to the mould insert cavity.

The continuous surface may be a flushed surface between sections or regions of the mould insert adjacent to the embossed section and sections or regions of the mould adjacent to the mould insert cavity.

The mould may include at least one aperture or borehole to receive a fastener to removably attach a replaceable mould insert.

The mould may be made from a range of materials. Suitably, the mould is made from a material that can withstand temperatures exceeding 1,000° C. Suitable materials include metals, metal alloys or ceramics. Examples of suitable materials include stainless steel, aluminium, and brass or bronze alloys including silicon bronze and aluminium bronze.

The mould may be made of material that is capable of withstanding temperatures during the bottle forming process which typically exceed 1,000° C. when forming glass bottles. This is in contrast to the operating temperatures during the blow moulding of plastic bottles which are typically less than 300° C.

The present invention also provides a mould insert for use in forming the above bottle, the mould insert comprising an embossed section that defines a bottle identification indicium when the mould insert is located in the above mould.

Suitably, the mould insert is configured to be removably attached to the previously described bottle mould.

The embossed sections of the mould defining bottle identification indicium are prone to damage and often wear out before the end of the normal lifespan of the mould. Typically, when this occurs, the entire mould has to be replaced. The mould insert increases the longevity of the mould by allowing the mould insert (i) to be repaired or replaced without having to replace the entire mould or (ii) removed to allow repairs to be performed on other parts of the mould while retaining the integrity of the bottle identification indicium.

The mould insert may be configured to receive a fastener to be removably attached to a bottle mould.

The mould insert may include an aperture or borehole to receive a fastener to be removably attached to a bottle mould.

The region of the mould insert surrounding the embossed section of the mould insert may have a surface profile that forms a flushed surface between the mould insert and the mould.

The embossed section may be located on a front wall of the mould insert. Suitably, the front wall of the mould insert on which the embossed section is located has a concave surface profile which conforms to a surface profile of a bottle formed in the mould.

The mould insert may have an opposing rear wall which includes at least one aperture or borehole to receive a fastener to reversibly fix the insert to the mould.

The mould insert may have a generally plate-shaped body having cross-sectional profile that conforms to the shape of the mould insert cavity. Suitably, the mould insert has a rear wall that is insertable into the mould insert cavity to secure the mould insert to the mould.

The mould insert may be made from a range of materials. Suitably, the mould insert is made from a metallic material.

The mould insert may be made formed using the same materials used to form the mould. Suitably, the mould insert is made from silicon bronze or aluminium bronze.

The present invention also provides a mould assembly comprising the above mould and the above mould insert retained in the mould.

### BRIEF DESCRIPTION OF DRAWINGS

An embodiment of the invention is hereinafter described by way of example only with reference to the accompanying drawings, wherein:

FIG. 1 is a side view of a wine bottle according to the prior art having an in-swept heel;

FIG. 2 is a side view of a wine bottle according to one form of the invention having a squared heel;

FIG. 3 is a photograph of a wine bottle according to FIG. 2 having debossed bottle identification indicia;

FIG. 4 is an exploded perspective view of a lower section of a female half mould which illustrates in detail a mould insert cavity that forms part of the mould and an accompanying mould insert;

FIG. 5 is an exploded perspective view of a bottle mould according to one form of the invention;

FIG. 6 is an internal side view of the female half mould of the bottle mould in FIG. 5;

FIG. 7 is an external side view of the female half mould of the bottle mould in FIG. 5;

FIG. 8 is a cross-sectional view of the female half mould of FIG. 7 along the D-D axis;

FIG. 9 is a perspective view of a mould insert according to another form of the invention;

FIG. 10 is a rear view of the mould insert of FIG. 9;

FIG. 11 is a top view of the mould insert of FIG. 9; and

FIG. 12 is a front view of the mould insert of FIG. 9.

### DETAILED DESCRIPTION

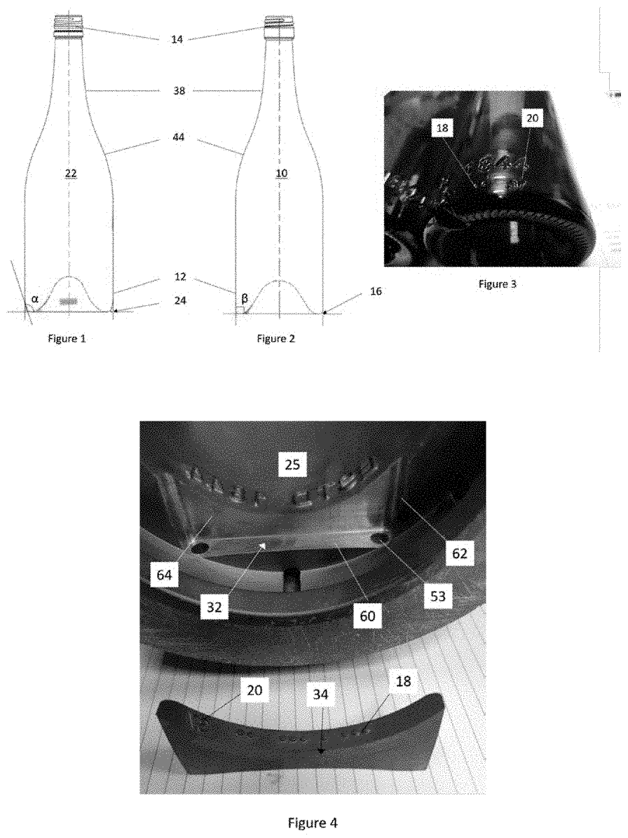

The present invention provides a bottle 10, which in this embodiment of the invention is a glass bottle, comprising a base 12 at one end, a neck 38 with an opening 14 at an opposing end, a cylindrical side wall 42 extending from the base 12, and a transition 44 between the side wall 42 and the neck 38 (see FIGS. 2 and 3).

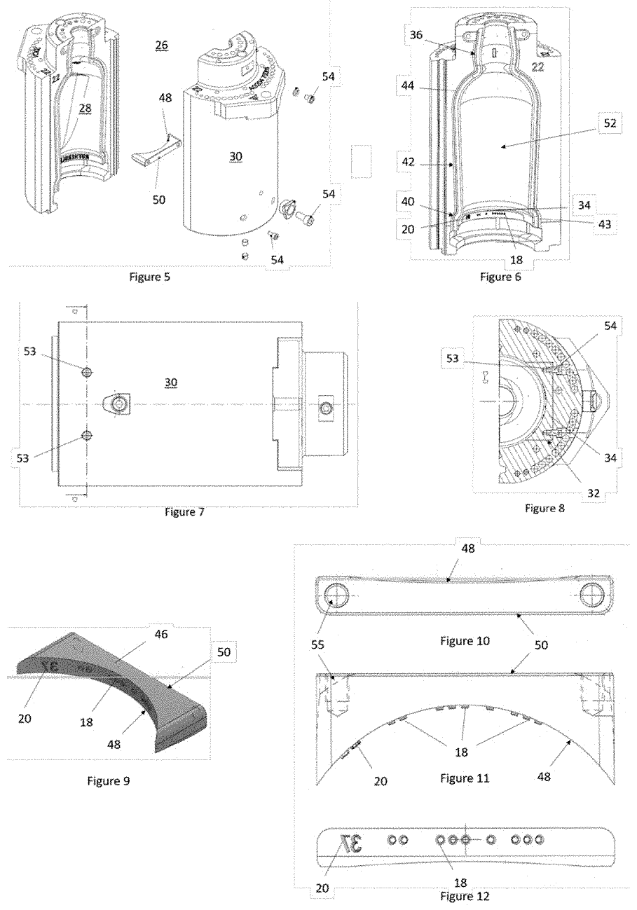

The bottle 10 may have any suitable shape, with another example of a bottle shape evident from FIGS. 5 to 8.

The base 12 has a squared heel 16 (i.e. a heel that has an angle β of 90°—see FIG. 2). This is in contrast to a traditional wine bottle 22 which has an in-swept heel 24 (i.e. a heel having an angle α is greater than 90°—see FIG. 1).

A lower section of the bottle 10 has debossed sections 18, 20 that define bottle identification indicia in the form of CID dots and a cavity number, respectively (see FIG. 3).

With reference to FIG. 3, the debossed sections 18, 20 are positioned in a lower section of the side wall 42 of the bottle above the base 12 of the bottle. The debossed sections 18, 20 extend a part of the way around the circumference of the lower section of the side wall 42. It is noted that the term “lower section of the bottle” includes the base 12 and a lower section of the cylindrical section 42.

The bottle 10 is formed by a blow moulding method using a bottle mould 25. Bottle mould 25 is a split mould comprising male and female half moulds (also known as plugs) that can be positioned together to form a closed mould. The mould 25 is made of silicon bronze.

FIG. 4 illustrates a perspective view of a lower section of the female half mould of the bottle mould 25. The lower section includes a mould insert cavity 32 that is shaped to receive a replaceable mould insert 34 for forming the debossed sections 18, 20 in the bottle 10.

The mould insert cavity 32 and the mould insert 34 are formed so that the mould insert 34 is snuggly received in the mould insert cavity 32.

The mould insert cavity 32 is located at a shoulder portion of the female half mould and comprises a flat rear wall 60, parallel side walls 62 and an upper wall 64. It can be appreciated from FIG. 4 that the mould insert 34 shown in the Figure can be positioned in the mould insert cavity so that the concave front wall 48 of the mould insert 34 (described further below) defines a continuous concave surface as part of the internal surface of the female mould half.

The rear wall 60 includes apertures 53 to receive fasteners such as screws to engage and secure the mould insert 34 in the mould insert cavity.

The mould insert 34 shown in FIGS. 4, 5 and 9 to 12 comprises a generally plate-shaped body with flat parallel upper and lower walls and flat parallel side walls. The mould insert 34 is made from either silicon bronze or aluminium bronze.

The mould insert 34 also comprises a front wall 48 with a concave surface profile with embossments, i.e., projections, that form bottle identification indicia in the form of CID dots and a cavity number in a moulded bottle. The mould insert also comprises an opposing rear wall 50 having a flat surface. The rear wall 50 having a pair of boreholes 55 to receive socket head cap screws 54 to fix the mould insert in the cavity.

Another example of a bottle mould is shown in FIGS. 5 to 8 which forms a bottle with a slightly different profile to the bottle 10 shown in FIGS. 2 and 3. The invention extends to different bottle shapes and consequently different mould shapes, noting that the moulds have the same basic structural features.

The location and shape of the mould insert cavities as well as the shape of the mould inserts 34 of bottle moulds 25 and 26 are similar.

With reference to FIGS. 5 to 8, the bottle mould 26 is a split mould comprising a male half mould 28 and a female half mould 30 that can be positioned together to form a closed mould.

Each half mould defines a mould cavity that defines the shape of the bottle and comprises:
(a) an upper section 36 that forms a neck 38 with an opening 14 of a bottle;
(b) a lower section 40 that forms a base 12 of the bottle;
(c) a middle section 42 that forms a cylindrical side wall 42 of the bottle;
(d) a first shoulder portion 44 that forms the transition 44 between the neck 38 and the side wall 42 of the bottle; and
(e) a second shoulder portion 43 that forms a transition between the side wall 42 and the base 12 of the bottle.

The second shoulder portion 43 of the female half mould 30 includes a mould insert cavity 32 to receive a replaceable mould insert 34 for forming the debossed sections 18, 20 in the bottle produced in the mould 26. The mould insert cavity 32 is shown in FIG. 8. It has a complementary shape to the mould insert 34, as described further below.

The mould and mould insert are preferably formed using stainless steel.

When the mould insert 34 is received in the mould insert cavity 32, the front wall of the mould insert 34 forms a continuous concave surface in the bottle mould cavity 52.

The concave surface profile and the depth of the mould insert 34 are set such that the front wall of the mould insert 34 is flushed with internal regions of the bottle mould around the front wall of the mould insert 34 when the mould insert 34 is attached to the mould insert cavity 32 (see FIG. 6). This ensures that the outline of the mould insert 34 is not imprinted onto the formed bottle and potentially introducing a region of weakness.

In a moulding operation to form a bottle, the mould insert 34 is inserted into the mould insert cavity 32 in the female half mould 30 and secured by fastening socket head cap screws 54 in apertures 53 of the female half mould. The socket head cap screws 54 extend into boreholes 53 in the rear wall of the mould insert 34 to fix the mould insert to the mould. Socket head cap screws are also used at other locations on the female half mould to interconnect the male and female half moulds together to form the complete bottle mould 26. Once attached, the concave surface of the mould insert 34 forms a continuous surface as part of the internal surface of the female half mould 30.

Molten glass is supplied into the mould and a bottle is formed by blow moulding. During the bottle forming step, the projections that form CID dots and a cavity number on the mould insert 34 form corresponding debossed features on the moulded bottle surface.

One advantage of the mould insert 34 is that it can be easily replaced if the projections are damaged without having to replace the entire mould. The mould insert 34 can also be removed to allow a damaged bottle mould to be replaced or repaired without damaging the mould insert.

Once the glass of the moulded bottle has cooled, the mould is disassembled to release the bottle. The formed bottle has a flared base with a squared heel (similar to the squared heel 16 of bottle 10 in FIG. 2) that is moulded with debossed CID dots and a cavity number.

The bottle is thereafter transported to a filling line to fill the bottle with wine and subsequently directed to a packaging line to package the bottled wine. The debossed CID dots and the cavity number on the bottle prevent these indicia from being damaged as a consequence of the constant contact of bottles with each other on the packaging and filling lines.

The preservation of these features ensures that information on the bottle such as the source and production details is accessible by visual inspection or can be machine read.

It also allows wine bottles with contemporary designs having a squared heel to be formed without having the shape of the bottle jeopardise the integrity of the bottle.

It will be understood to persons skilled in the art of the invention that many modifications may be made without departing from the spirit and scope of the invention.

By way of example, whilst the embodiments shown in the Figures include particular shapes of a mould insert and a mould having a mould insert cavity, it can readily be appreciated that the invention is not confined to these particular arrangements and extends to any suitable shapes of the mould insert and the mould.

In particular, it is noted that the invention extends to any suitable mould structure that can receive and support a mould insert that has projections on a surface of the insert that extend into a mould cavity and form debossed sections in a moulded bottle. It can be appreciated therefore that the invention extends to moulds that do not necessarily mould cavities for receiving and supporting mould inserts.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A bottle formed from a brittle material comprising a base at one end, a neck with an opening at an opposing end, a side wall extending from the base, and a transition between the side wall and the neck, with a lower section including a debossed section that defines a bottle identification indicium.

2. The bottle according to claim 1, having a squared heel.

3. The bottle according to claim 1, having an out-swept heel in which the angle between a side wall and a base of the bottle is less than 90°.

4. A mould for forming the bottle according to claim 1, the mould comprising a mould cavity that defines the shape of the bottle, with the mould being formed to receive a replaceable mould insert that includes an embossed section for forming the debossed section in the lower section of the bottle produced in the mould.

5. The mould according to claim 4, wherein the mould is a split mould.

6. The mould according to claim 5, wherein the split mould is a two-part split mould.

7. The mould according to claim 4, including a replaceable mould insert having an embossed section for forming the debossed section in the lower section of a bottle produced in the mould.

8. The mould according to claim 4, being configured to receive any number of mould inserts and includes a corresponding number of mould insert cavities to receive the mould inserts.

9. The mould according to claim 4, including a mould insert cavity being any suitably shaped cavity or formation of the mould that can receive a replaceable mould insert.

10. The mould according to claim 9, wherein the mould insert cavity is shaped to receive a replaceable mould insert that includes an embossed section for forming the debossed section in the lower section of the bottle produced in the mould such that sections of the replaceable mould insert adjacent to the embossed section forms a continuous surface with sections of the mould adjacent to the mould insert cavity.

11. The mould according to claim 4, including at least one aperture or borehole to receive a fastener to removably attach a replaceable mould insert.

12. A mould insert for use in forming a bottle, the mould insert comprising an embossed section that defines a bottle identification indicium when the mould insert is located in the mould.

13. The mould insert according to claim 12, configured to be removably attached to a bottle mould.

14. The mould insert according to claim 4, being configured to receive a fastener to be removably attached to a bottle mould.

15. The mould insert according to claim 14, including an aperture or borehole to receive a fastener to be removably attached to a bottle mould.

16. The mould insert according to claim 12, wherein regions of the replaceable mould insert adjacent to the embossed section is flushed with sections of the mould adjacent to the mould insert cavity.

17. The mould insert according to claim 12, having a cross-sectional profile that conforms to the shape of the mould insert cavity.

18. The mould insert according to claim 12, having a generally plate-shaped body having a front wall that is shaped to conform to the shape of the mould insert cavity.

19. The mould insert according to claim 17, including a rear wall that has at least one aperture or borehole to receive a fastener to be removably attached to a bottle mould.

20. (canceled)
